(19) United States
(12) Patent Application Publication
(10) Pub. No.: US 2023/0392938 A1
(43) Pub. Date: Dec. 7, 2023

(54) NAVIGATION INFORMATION PROCESSING METHOD, ELECTRONIC DEVICE, AND STORAGE MEDIUM

(71) Applicant: GUANGZHOU ASENSING TECHNOLOGY CO., LTD., Guangzhou (CN)

(72) Inventors: Jiede WANG, Guangzhou (CN); Chunhui SITU, Guangzhou (CN); Leijin HAN, Guangzhou (CN); Jing PANG, Guangzhou (CN)

(73) Assignee: GUANGZHOU ASENSING TECHNOLOGY CO., LTD., Guangzhou (CN)

(21) Appl. No.: 18/454,966

(22) Filed: Aug. 24, 2023

Related U.S. Application Data
(63) Continuation of application No. PCT/CN2022/077896, filed on Feb. 25, 2022.

(30) Foreign Application Priority Data
Feb. 25, 2021 (CN) 202110214125.4

(51) Int. Cl. G01C 21/34; G01C 21/16; H04L 12/40

(52) U.S. Cl. CPC G01C 21/3446; G01C 21/165; G01C 21/188; H04L 12/40; H04L 2012/40215; H04L 2012/40273

(57) ABSTRACT

A navigation information processing method includes: acquiring motion state information of a vehicle based on an inertial device, and acquiring vehicle information of the vehicle based on a controller area network; performing a strapdown solution on the motion state information to obtain navigation information; fusing the navigation information and the vehicle information by using a preset Kalman filter to obtain target navigation information; and navigating the vehicle based on the target navigation information. Data collection does not need to rely on environment, and problems of unstable navigation effects caused by insufficient acquired data are solved. A Kalman filter is used to fuse navigation information and vehicle information, improving accuracy of navigation information and precision of positioning. A two-dimensional vector is used as an input vector of the Kalman filter, which has a simple filtering manner and consumes few hardware resources, reducing navigation costs.

### CROSS-REFERENCE TO RELATED APPLICATIONS

This application is a continuation application of International Application No. PCT/CN2022/077896, filed on Feb. 25, 2022, which claims priority to Chinese Patent Application No. 202110214125.4, filed on Feb. 25, 2021. Both applications are incorporated herein by reference in their entireties.

### TECHNICAL FIELD

This application relates to the field of computer technologies, and specifically, to a navigation information processing method, an electronic device, and a storage medium.

### BACKGROUND

With the rapid development of the modern vehicle industry, intelligent driving has currently become a development trend of the vehicle industry. Smart driving is an important breakthrough combining the industrial revolution and informatization, which can change a flow mode of people, resource elements, and products, and dramatically change human life. Smart driving refers to a technology in which a machine assists a person in driving, and completely replaces a human driver in a special case.

In a related technology, technologies such as machine vision, satellite positioning, and laser radar positioning are widely applied to smart driving. However, in order to improve accuracy, more and more data is required in the foregoing technologies, algorithm units are also becoming larger and larger, and thus increasingly high requirements are proposed for software and hardware, ultimately making it difficult to popularize a smart driving technology. However, smart driving currently has problems of high navigation costs and unstable navigation effect.

### SUMMARY

Objectives of embodiments of the present application are to provide a navigation information processing method, an electronic device, and a storage medium, to solve problems of high navigation costs and unstable navigation effects currently existing in vehicle navigation.

According to a first aspect, an embodiment of the present application provides a navigation information processing method, including: acquiring motion state information of a vehicle based on an inertial device, and acquiring vehicle information of the vehicle based on a controller area network; performing a strapdown solution on the motion state information to obtain navigation information; fusing the navigation information and the vehicle information by using a preset Kalman filter to obtain target navigation information, where an input vector of the Kalman filter is a two-dimensional vector; and navigating the vehicle based on the target navigation information.

In this embodiment, motion state information of a vehicle acquired based on an inertial device and vehicle information of the vehicle acquired based on a controller area network are used as input data, so that data collection does not need to rely on an environment, solving problems of unstable navigation effects caused by insufficient acquired data. Navigation information is obtained based on the motion state information, thereby implementing positioning independent of environment information. A Kalman filter is used to fuse navigation information and vehicle information, so that the vehicle information is used to correct the navigation information, improving accuracy of the navigation information and precision of positioning. In addition, the two-dimensional vector is used as an input vector of the Kalman filter, which has a simple filtering manner and consumes few hardware resources, reducing navigation costs.

Further, the acquiring motion state information of a vehicle based on an inertial device includes: acquiring a three-axis acceleration and a three-axis angular velocity of the vehicle based on the inertial device; calculating position coordinates, a three-dimensional motion velocity, and an attitude quaternion of the vehicle based on the three-axis acceleration and the three-axis angular velocity; and constructing a state vector of the vehicle based on the position coordinates, the three-dimensional motion velocity, and the attitude quaternion, and using the state vector as the motion state information.

In this embodiment, the position coordinates, the three-dimensional motion velocity, and the attitude quaternion of a vehicle are obtained by means of calculation based on an inertial device, and on such as basis, the motion state information is obtained, so that data collection does not need to rely on an environment, thereby reducing data collection difficulty.

Further, the acquiring vehicle information of the vehicle based on a controller area network includes: acquiring, based on the controller area network, a target steering angle and a target movement velocity of the vehicle in a target time period; calculating an angle residual value of the target steering angle and a velocity residual value of the target movement velocity; and using the target steering angle and the target movement velocity as the vehicle information when the angle residual value is less than a first preset threshold and the velocity residual value is less than a second preset threshold.

In this embodiment, the angle residual value and the velocity residual value are calculated to identify whether the target steering angle and the target movement velocity become suddenly too large or too small, so as to ensure that the target steering angle and the target movement velocity are available data, and further ensure accuracy of a navigation information calculation result.

Further, the acquiring, based on the controller area network, a target steering angle and a target movement velocity of the vehicle in a target time period includes: acquiring, based on the controller area network, a steering angle and a movement velocity of the vehicle in the target time period; determining a first difference value between a time for acquiring the steering angle and a time for acquiring the motion state information, and a second difference value between a time for acquiring the movement velocity and a time for acquiring the motion state information; and using the steering angle as the target steering angle and using the movement velocity as the target movement velocity when both the first difference value and the second difference value are less than a preset difference value.

In this embodiment, data alignment is performed on the steering angle, the movement velocity, and the motion state information by means of an acquisition time, to ensure that the foregoing data are collected at a same time, and data bias is reduced, so as to improve data accuracy.

Further, the motion state information includes position coordinates, a three-dimensional motion velocity, and an attitude quaternion, and the performing a strapdown solution on the motion state information to obtain navigation information includes: separately performing differentiation on the position coordinates, the three-dimensional motion velocity, and the attitude quaternion to obtain a first derivative result, where a derivative result of the three-dimensional motion velocity is a three-dimensional motion acceleration; performing bias correction on the three-dimensional motion acceleration in the first derivative result to obtain a second derivative result; and performing fourth-order approximation operation on the second derivative result to obtain the navigation information.

In this embodiment, the three-dimensional motion acceleration is corrected to reduce an adverse effect of a gravitational acceleration, and the fourth-order approximation operation is performed on the second derivative result to improve accuracy of the navigation information.

Further, the performing bias correction on the three-dimensional motion acceleration in the first derivative result to obtain a second derivative result includes: performing the bias correction on the three-dimensional motion acceleration by using a preset calculation formula to obtain an acceleration correction result, and forming the second derivative result by using a derivative result of the position coordinates, a derivative result of the attitude quaternion, and the acceleration correction result, where the preset calculation formula is as follow:

f_{xyz}=C_{b}ⁿf_{sf}^{b}−(2wᵢₑ+wₑₙ)×vₑₙ+g

where f_{xyz} is an acceleration correction result, C_{b}ⁿ is a navigation coordinate system, f_{sf}^{b} is a three-dimensional motion acceleration, 2wᵢₑ×vₑₙ is a Coriolis acceleration caused by vehicle motion and rotation of the earth, wₑₙ×vₑₙ is a centripetal acceleration to the ground caused by the vehicle motion, and g is a gravitational acceleration.

In this embodiment, the gravitational acceleration and the Coriolis acceleration are removed, so as to eliminate an adverse effect of a harmful acceleration on the three-dimensional motion acceleration, thereby improving accuracy of a calculation result.

Further, the vehicle information includes a steering angle and a movement velocity, and the fusing the navigation information and the vehicle information by using a preset Kalman filter to obtain target navigation information includes: obtaining an angle residual value of the steering angle and a velocity residual value of the movement velocity; forming a two-dimensional observation vector by using the steering angle and the movement velocity, and forming an observation noise by using the angle residual value and the velocity residual value; calculating a Kalman gain value of the Kalman filter based on the observation noise; and performing data correction on the navigation information based on the two-dimensional observation vector and the Kalman gain value to obtain the target navigation information.

In this embodiment, the Kalman gain value is calculated by using the observation noise formed by the residual values, and the navigation information is corrected by using the two-dimensional observation vector formed by the steering angle and the movement velocity, so that the navigation information is corrected by using the vehicle information, noise impact is eliminated, and data accuracy is improved.

According to a second aspect, an embodiment of the present application provides a navigation information processing apparatus, including: an acquisition module, configured to acquire motion state information of a vehicle based on an inertial device, and acquire vehicle information of the vehicle based on a controller area network; a solution module, configured to perform a strapdown solution on the motion state information to obtain navigation information; a fusion module, configured to fuse the navigation information and the vehicle information by using a preset Kalman filter to obtain target navigation information, where an input vector of the Kalman filter is a two-dimensional vector; and a navigation module, configured to navigate the vehicle based on the target navigation information.

According to a third aspect, an embodiment of the present application provides an electronic device, including a memory and a processor. The memory is configured to store a computer program, and the processor runs the computer program to cause the electronic device to perform the navigation information processing method according to the first aspect.

According to a fourth aspect, an embodiment of the present application provides a computer-readable storage medium on which a computer program is stored. When the computer program is executed by a processor, the navigation information processing method according to the first aspect is implemented.

It may be appreciated that, for beneficial effects of the second aspect to the fourth aspect, reference may be made to the related description in the first aspect, and details are not repeated herein.

### BRIEF DESCRIPTION OF THE DRAWINGS

To describe the technical solutions in embodiments of the present application more clearly, the following briefly describes the accompanying drawings required in the embodiments of the present application. It should be appreciated that the accompanying drawings in the following description show some embodiments of the present application, and therefore should not be taken as limiting the scope. A person of ordinary skill in the art may still derive other drawings from these accompanying drawings without creative efforts.

FIG. 1 is a schematic diagram of a navigation information processing method according to an embodiment of the present application.

FIG. 2 is a structural block diagram of a navigation information processing apparatus according to an embodiment of the present application.

FIG. 3 is a schematic structural diagram of an electronic device according to an embodiment of the present application.

### DETAILED DESCRIPTION OF THE EMBODIMENTS

The following describes the technical solutions in the embodiments of the present application in combination with the accompanying drawings in the embodiments of the present application.

It should be noted that similar reference signs and letters indicate similar items in the following drawings. Therefore, once a specific item is defined in one drawing, it does not need to be further defined and explained in the subsequent drawings. In addition, in description of the present application, the terms “first”, “second” and the like are merely intended for purposes of description, and shall not be understood as an indication or implication of relative importance.

In current technologies, due to closure and instability of light source in an underground garage, many devices participating in positioning cannot provide a large amount of data, leading to failure of the devices, and causing problems of high navigation costs and unstable navigation effects.

In view of the problems in the conventional technologies, the present application provides a navigation information processing method. According to the method, motion state information of a vehicle acquired based on an inertial device and vehicle information of the vehicle acquired based on a controller area network are used as input data, so that data collection does not need to rely on an environment, solving problems of unstable navigation effects caused by insufficient acquired data. Navigation information is obtained based on the motion state information, thereby implementing positioning independent of environment information. A Kalman filter is used to fuse navigation information and vehicle information, so that the vehicle information is used to correct the navigation information, improving accuracy of the navigation information and precision of positioning. In addition, a two-dimensional vector is used as an input vector of the Kalman filter, which has a simple filtering manner and consumes few hardware resources, reducing navigation costs.

Referring to FIG. 1, FIG. 1 is a schematic diagram of a navigation information processing method according to an embodiment of the present application. The navigation information processing method described below in the embodiments of the present application may be applied to an electronic device, and the electronic device includes, but is not limited to, a vehicle-mounted computer, a smartphone, a tablet computer, a desktop computer, a supercomputer, a personal digital assistant, a physical server, a cloud server, and another computer device that are in communication connection with a CAN bus of a vehicle. The navigation information processing method in the embodiment of the present application includes Step S101 to Step S104, and details are as follows.

Step S101: Acquiring motion state information of a vehicle based on an inertial device, and acquiring vehicle information of the vehicle based on a controller area network.

In this embodiment, the inertial device includes, but is not limited to, a three-dimensional acceleration sensor, a three-dimensional angular velocity sensor, a gyroscope, and the like, and may be installed on a body of the vehicle. The controller area network (Controller Area Network, CAN) is a standard bus of a vehicle computer control system and an embedded industrial control area network, and includes vehicle CAN information such as a vehicle velocity, a wheel speed and a steering angle. The motion state information is a current motion condition of the vehicle, which includes, but is not limited to, a velocity, an acceleration, an attitude angle, and the like of the vehicle, and the vehicle information is CAN information of the vehicle.

In this embodiment, the motion state information of a vehicle acquired based on an inertial device and the vehicle information of the vehicle acquired based on a controller area network are used as input data, so that data collection does not need to rely on an environment, solving problems of unstable navigation effects caused by insufficient acquired data.

In an embodiment, the acquiring motion state information of a vehicle based on an inertial device includes: acquiring a three-axis acceleration and a three-axis angular velocity of the vehicle based on the inertial device; calculating position coordinates, a three-dimensional motion velocity, and an attitude quaternion of the vehicle based on the three-axis acceleration and the three-axis angular velocity; and constructing a state vector of the vehicle based on the position coordinates, the three-dimensional motion velocity, and the attitude quaternion, and using the state vector as the motion state information.

In this embodiment, the three-axis acceleration of a vehicle may be acquired based on a three-dimensional acceleration sensor, and the three-axis angular velocity of the vehicle may be acquired based on a three-dimensional angular velocity sensor. A starting point of the vehicle is used as an origin of coordinates, and the current position coordinates (pₓ, p_{y}, p_{z}), the three-dimensional motion velocity (vₓ, v_{y}, v_{z}), and the attitude quaternion (q₀, q₁, q₂, q₃) formed by an attitude angle are calculated based on the three-axis acceleration and the three-axis angular velocity, finally constructing the state vector Xₙ={pₓp_{y}p_{z}vₓv_{y}v_{z}q₀q₁q₂q₃}.

In this embodiment, the position coordinates, the three-dimensional motion velocity, and the attitude quaternion of a vehicle are obtained by means of calculation based on an inertial device, and on such as basis, the motion state information is obtained, so that data collection does not need to rely on an environment, thereby reducing data collection difficulty.

Optionally, the acquiring vehicle information of the vehicle based on a controller area network includes: acquiring, based on the controller area network, a target steering angle and a target movement velocity of the vehicle in a target time period; calculating an angle residual value of the target steering angle and a velocity residual value of the target movement velocity; and using the target steering angle and the target movement velocity as the vehicle information when the angle residual value is less than a first preset threshold and the velocity residual value is less than a second preset threshold.

In this embodiment, with regard to the target movement velocity, a difference between adjacent target movement velocities in a time period is calculated to obtain a difference value V_{d}. A quantity m of V_{d}_{^{s}} greater than a preset value is determined; the V_{d}_{^{s}} greater than the preset value are summed to obtain Vₛᵤₘ; and the velocity residual value

$${E}_{v} = \frac{abs ( {V}_{sum} )}{{m}^{2}}$$

is calculated based on the following formula. When the velocity residual value is less than the first preset threshold, it indicates that the target movement velocity in the time period is available data. It may be appreciated that, as for calculation of the angle residual value, reference may be made to an operation manner of the velocity residual value, and details are not described herein again.

In this embodiment, the angle residual value and the velocity residual value are calculated to identify whether the target steering angle and the target movement velocity become suddenly too large or too small, so as to ensure that the target steering angle and the target movement velocity are available data, and further ensure accuracy of a navigation information calculation result.

In a possible implementation, the acquiring, based on the controller area network, a target steering angle and a target movement velocity of the vehicle in a target time period includes: acquiring, based on the controller area network, a steering angle and a movement velocity of the vehicle in the target time period; determining a first difference value between a time for acquiring the steering angle and a time for acquiring the motion state information, and a second difference value between a time for acquiring the movement velocity and a time for acquiring the motion state information; and using the steering angle as the target steering angle and using the movement velocity as the target movement velocity when both the first difference value and the second difference value are less than a preset difference value.

In this implementation, a time for acquiring each of the steering angle, the movement velocity, and the motion state information is recorded, where the time for acquiring the motion state information may be specifically a time for acquiring the three-axis acceleration and the three-axis angular velocity. Data alignment is performed on the steering angle, the movement velocity, and the motion state information by means of an acquisition time. When the first difference value is less than the preset difference value, it indicates that the steering angle and the motion state information are obtained in a same time period. When the second difference value is less than the preset difference value, it indicates that the movement velocity and the motion state information are acquired in a same time period. When the first difference value and the second difference value are both less than the preset difference value, it indicates that the steering angle, the movement velocity, and the motion state information are obtained in a same time period. In this embodiment, it is ensured that the foregoing data are collected at a same time, and data bias is reduced, so as to improve data accuracy.

Step S102: Performing a strapdown solution on the motion state information to obtain navigation information.

In this embodiment, the strapdown solution is a strapdown inertial navigation solution, and strapdown means to fixedly connect to a carrier (a vehicle). In this embodiment, the motion state information includes position coordinates, a three-dimensional motion velocity, and an attitude quaternion. A strapdown solution process may be a process that differentiation is performed on the motion state information to obtain the navigation information, thereby implementing positioning independent of environment information.

In an embodiment, the performing a strapdown solution on the motion state information to obtain navigation information includes: separately performing differentiation on the position coordinates, the three-dimensional motion velocity, and the attitude quaternion to obtain a first derivative result, where a derivative result of the three-dimensional motion velocity is a three-dimensional motion acceleration; performing bias correction on the three-dimensional motion acceleration in the first derivative result to obtain a second derivative result; and performing fourth-order approximation operation on the second derivative result to obtain the navigation information.

In this embodiment, the motion state information Xₙ={pₓp_{y}p_{z}vₓv_{y}v_{z}q₀q₁q₂q₃}, a derivative result of the position coordinates (pₓ, p_{y}, p_{z}) is a velocity (uₓ, u_{y}, u_{z}), a derivative result of the three-dimensional motion velocity (vₓ, v_{y}, v_{z}) is the three-dimensional motion acceleration (aₓ, a_{y}, a_{z}), and a derivative result of the attitude quaternion (q₀, q₁, q₂, q₃) is an attitude angle w_{dot}; and in this case, the first derivative result is X_{n-1dot}={uₓu_{y}u_{z}aₓ a_{y} a_{z}w_{dot}}. After the three-dimensional motion acceleration (aₓ, a_{y}, a_{z}) is corrected, an acceleration (fₓ, f_{y}, f_{z}) is obtained; and in this case, the second derivative result is X_{ndot}={uₓu_{y}u_{z}fₓf_{y}f_{z}w_{dot}}.

For example, the fourth-order approximation operation is performed on the second derivative result by calculating a slope K, which is specifically as follows:

$${K}_{1} = {X}_{ndot} ;$$

$${X}_{n + 1} = {X}_{n} + \frac{dt}{2} \times {K}_{1} ;$$

$${K}_{2} = {X}_{n + 1 dot} ;$$

$${X}_{n + 2} = {X}_{n + 1} + \frac{dt}{2} \times {K}_{2} ;$$

$${K}_{3} = {X}_{n + 2 dot} ;$$

$${X}_{n + 3} = {X}_{n + 2} + dt \times {K}_{3} ;$$

$${K}_{4} = {X}_{n + 3 dot} ;$$

$${X}_{n + 4} = {X}_{n} + \frac{dt}{6} ( {K}_{1} + 2 \times {K}_{2} + 2 \times {K}_{3} + {K}_{4} ) ,$$

where Xₙ₊₄ is the navigation information, including a vehicle position, a motion velocity, and an attitude quaternion.

Optionally, the performing bias correction on the three-dimensional motion acceleration in the first derivative result to obtain a second derivative result includes: performing the bias correction on the three-dimensional motion acceleration by using a preset calculation formula to obtain an acceleration correction result, and forming the second derivative result by using a derivative result of the position coordinates, a derivative result of the attitude quaternion, and the acceleration correction result, where the preset calculation formula is as follow:

f_{xyz}=C_{b}ⁿf_{sf}^{b}−(2wᵢₑ+wₑₙ)×vₑₙ+g

where f_{xyz} is an acceleration correction result, C_{b}ⁿ is a navigation coordinate system, f_{sf}^{b} is a three-dimensional motion acceleration, 2wᵢₑ×vₑₙ is a Coriolis acceleration caused by vehicle motion and rotation of the earth, wₑₙ×vₑₙ is a centripetal acceleration to the ground caused by the vehicle motion, and g is a gravitational acceleration.

In this embodiment, the gravitational acceleration and the Coriolis acceleration are removed, so as to eliminate an adverse effect of a harmful acceleration on the three-dimensional motion acceleration, thereby improving accuracy of a calculation result.

Step S103: Fusing the navigation information and the vehicle information by using a preset Kalman filter to obtain target navigation information, where an input vector of the Kalman filter is a two-dimensional vector.

In this embodiment, the Kalman filter is an algorithm used to perform an optimal estimation on a system state based on system input and output observation data by using a linear system state equation. Since the observation data includes impact of noise and interference in the system, the optimal estimation may also be considered as a filtering process. Due to existence of bias in the navigation information to some extent, the navigation information is corrected. Specifically, in this embodiment, the navigation information is filtered by using the vehicle information, so that the navigation information is corrected by using the vehicle information, improving accuracy of the navigation information and precision of positioning. In addition, the two-dimensional vector is used as an input vector of the Kalman filter, which has a simple filtering manner and consumes few hardware resources, reducing navigation costs.

In an embodiment, the vehicle information includes a steering angle and a movement velocity, and the fusing the navigation information and the vehicle information by using a preset Kalman filter to obtain target navigation information includes: obtaining an angle residual value of the steering angle and a velocity residual value of the movement velocity; forming a two-dimensional observation vector by using the steering angle and the movement velocity, and forming an observation noise by using the angle residual value and the velocity residual value; calculating a Kalman gain value of the Kalman filter based on the observation noise; and performing data correction on the navigation information based on the two-dimensional observation vector and the Kalman gain value to obtain the target navigation information.

In this embodiment, the observation data is the steering angle and movement velocity

$${Z}_{k} = [ \begin{matrix}{W}_{veh} \\ {V}_{veh}\end{matrix} ] ,$$

and the observation noise is the angle residual value of the steering angle and velocity residual value of the movement velocity

$${R}_{k} = [ \begin{matrix}{E}_{w} \\ {E}_{v}\end{matrix} ] .$$

The Kalman gain is Kₖ=Pₖ⁻H_{K}^{T}(HₖPₖ⁻Hₖ^{T}+Rₖ)⁻¹, where H is a transition matrix, and P is a covariance; and a correction formula for performing data correction on the navigation information is \hat{X}ₖ⁺=\hat{X}ₖ⁻Kₖ(zₖ−Hₖ\hat{X}ₖ⁻), where \hat{X}ₖ⁻ is the latest navigation information. In order to obtain the Kalman gain during calculation of the navigation information next time, the covariance is updated according to Pₖ⁺=(I−KₖHₖ)Pₖ⁻.

In this embodiment, a Kalman gain value is calculated by using the observation noise formed by the residual values, and the navigation information is corrected by using the two-dimensional observation vector formed by the steering angle and the movement velocity, so that the navigation information is corrected by using the vehicle information, noise impact is eliminated, and data accuracy is improved.

Step S104: Navigating the vehicle based on the target navigation information.

In this embodiment, navigation of a vehicle in various environments is implemented based on the target navigation information obtained through calculation independent of an environment.

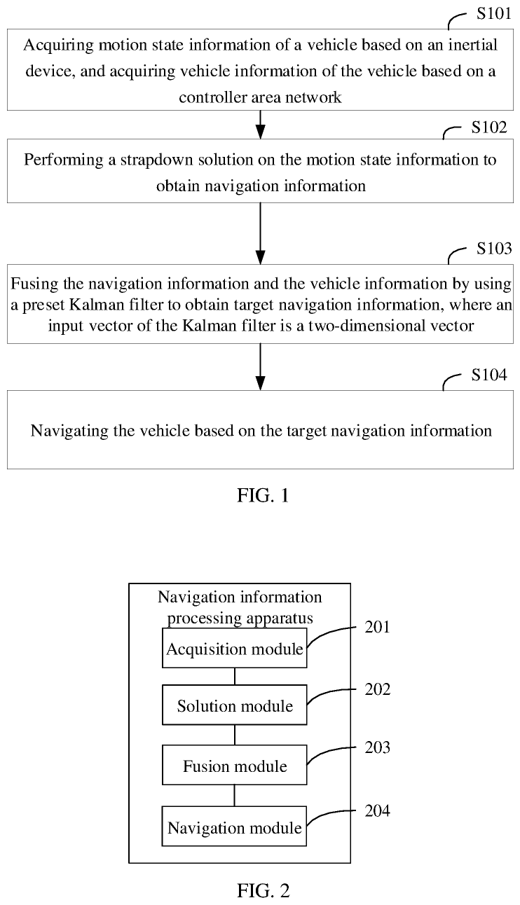

In order to perform corresponding methods in the foregoing method embodiments to implement corresponding functions and technical effects, a navigation information processing apparatus is provided below. Referring to FIG. 2, FIG. 2 is a structural block diagram of a navigation information processing apparatus according to an embodiment of the present application. Each module included in the apparatus in this embodiment is configured to perform each step in the embodiments corresponding to FIG. 1. For details, reference may be made to FIG. 1 and the related description in the embodiments corresponding to FIG. 1. For ease of description, only parts related to this embodiment are shown. The navigation information processing apparatus provided in the embodiment of the present application includes: an acquisition module 201, configured to acquire motion state information of a vehicle based on an inertial device, and acquire vehicle information of the vehicle based on a controller area network; a solution module 202, configured to perform a strapdown solution on the motion state information to obtain navigation information; a fusion module 203, configured to fuse the navigation information and the vehicle information by using a preset Kalman filter to obtain target navigation information, where an input vector of the Kalman filter is a two-dimensional vector; and a navigation module 204, configured to navigate the vehicle based on the target navigation information.

In an embodiment, the acquisition module 201 includes: a first acquisition unit, configured to acquire a three-axis acceleration and a three-axis angular velocity of the vehicle based on the inertial device; a first calculation unit, configured to calculate position coordinates, a three-dimensional motion velocity, and an attitude quaternion of the vehicle based on the three-axis acceleration and the three-axis angular velocity; and a construction unit, configured to construct a state vector of the vehicle based on the position coordinates, the three-dimensional motion velocity, and the attitude quaternion, and use the state vector as the motion state information.

In an embodiment, the acquisition module 201 further includes: a second acquisition unit, configured to acquire, based on the controller area network, a target steering angle and a target movement velocity of the vehicle in a target time period; a second calculation unit, configured to calculate an angle residual value of the target steering angle and a velocity residual value of the target movement velocity; and a using unit, configured to use the target steering angle and the target movement velocity as the vehicle information when the angle residual value is less than a first preset threshold and the velocity residual value is less than a second preset threshold.

In an embodiment, the second acquisition unit includes: an acquisition subunit, configured to acquire, based on the controller area network, a steering angle and a movement velocity of the vehicle in the target time period; a determining subunit, configured to determine a first difference value between a time for acquiring the steering angle and a time for acquiring the motion state information, and a second difference value between a time for acquiring the movement velocity and a time for acquiring the motion state information; and a using subunit, configured to use the steering angle as the target steering angle and use the movement velocity as the target movement velocity when both the first difference value and the second difference value are less than a preset difference value.

In an embodiment, the motion state information includes position coordinates, a three-dimensional motion velocity, and an attitude quaternion, and the solution module 202 includes: a differentiation unit, configured to separately perform differentiation on the position coordinates, the three-dimensional motion velocity, and the attitude quaternion to obtain a first derivative result, where a derivative result of the three-dimensional motion velocity is a three-dimensional motion acceleration; a first correction unit, configured to perform bias correction on the three-dimensional motion acceleration in the first derivative result to obtain a second derivative result; and an operation unit, configured to perform fourth-order approximation operation on the second derivative result to obtain the navigation information.

In an embodiment, the first correction unit includes: a correction subunit, configured to perform the bias correction on the three-dimensional motion acceleration by using a preset calculation formula to obtain an acceleration correction result, and form the second derivative result by using a derivative result of the position coordinates, a derivative result of the attitude quaternion, and the acceleration correction result, where the preset calculation formula is as follows:

f_{xyz}=C_{b}ⁿf_{sf}^{b}−(2wᵢₑ+wₑₙ)×vₑₙ+g,

where f_{xyz} is an acceleration correction result, Cₙ^{b} is a navigation coordinate system, f_{sf}^{b} is a three-dimensional motion acceleration, 2wᵢₑ×vₑₙ is a Coriolis acceleration caused by vehicle motion and rotation of the earth, wₑₙ×vₑₙ is a centripetal acceleration to the ground caused by the vehicle motion, and g is a gravitational acceleration.

In an embodiment, the vehicle information includes a steering angle and a movement velocity, and the fusion module 203 includes: a third acquisition unit, configured to obtain an angle residual value of the steering angle and a velocity residual value of the movement velocity; a forming unit, configured to form a two-dimensional observation vector by using the steering angle and the movement velocity, and form an observation noise by using the angle residual value and the velocity residual value; a third calculation unit, configured to calculate a Kalman gain value of the Kalman filter based on the observation noise; and a second correction unit, configured to perform data correction on the navigation information based on the two-dimensional observation vector and the Kalman gain value to obtain the target navigation information.

The navigation information processing apparatus may implement the navigation information processing method in the foregoing method embodiments. An optional implementation in the foregoing method embodiments is also applicable to this embodiment, and details are not described herein again. For other content in the embodiments of the present application, reference may be made to the content in the foregoing method embodiments, and details are not repeated in this embodiment.

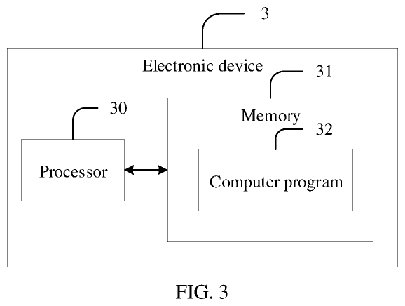

FIG. 3 is a schematic structural diagram of an electronic device according to an embodiment of the present application. As shown in FIG. 3, an electronic device 3 in this embodiment includes: at least one processor 30 (only one is shown in FIG. 3); a memory 31; and a computer program 32 that is stored in the memory 31 and runs on the at least one processor 30, where when the processor 30 executes the computer program 32, steps in any one of the foregoing method embodiments are implemented.

The electronic device 3 may be a computer device such as a smartphone, a tablet computer, a desktop computer, a supercomputer, a personal digital assistant, a physical server, and a cloud server. The electronic device 3 may include, but not limited to, a processor 30 and a memory 31. A person skilled in the art may appreciate that FIG. 3 only shows an example of the electronic device 3, and does not constitute a limitation on the electronic device 3. The electronic device 3 may include more or fewer components than those shown in the figure, or some combined components or different components. For example, the electronic device 3 may further include an input/output device, a network access device, and the like.

The processor 30 may be a central processing unit (Central Processing Unit, CPU), or may be another general-purpose processor, a digital signal processor (Digital Signal Processor, DSP), an application specific integrated circuit (Application Specific Integrated Circuit, ASIC), a field-programmable gate array (Field-Programmable Gate Array, FPGA), or another programmable logic device, a discrete gate, a transistor logic device, a discrete hardware component, or the like. The general-purpose processor may be a microprocessor, or the processor may be any conventional processor or the like.

In some embodiments, the memory 31 may be an internal storage unit of the electronic device 3, for example, a hard disk or a memory of the electronic device 3. In some other embodiments, the memory 31 may be an external storage device of the electronic device 3, for example, a plug-in hard disk, a smart media card (Smart Media Card, SMC), a secure digital (Secure Digital, SD) card, or a flash card (Flash Card) that is equipped on the electronic device 3. Further, the memory 31 may alternatively include both an internal storage unit and an external storage device of the electronic device 3. The memory 31 is configured to store an operating system, an application program, a boot loader (BootLoader), data, another program, and the like, for example, program codes of the computer program. The memory 31 may further be used to temporarily store data that has been output or is to be output.

In addition, an embodiment of the present application further provides a computer-readable storage medium. The computer-readable storage medium stores a computer program. When the computer program is executed by a processor, steps in any one of the foregoing method embodiments may be implemented.

An embodiment of the present application further provides a computer program product. When the computer program product runs on an electronic device, the steps in the foregoing various method embodiments may be implemented when the electronic device executes the computer program product.

In the several embodiments provided in the present application, it should be appreciated that the disclosed apparatus and method may be implemented in other manners. The apparatus embodiments described above are merely illustrative. For example, the flowcharts and block diagrams in the accompanying drawings show possible architectures, functions and operations of the apparatus, the method and the computer program product according to various embodiments of the present application. In this regard, each block in the flowchart or block diagram may represent a module, a program segment or a portion of a code, which contains one or more executable instructions for implementing a specified logical function. It should also be noted that in some alternative implementations, functions marked by blocks may also occur in an order differing from that marked in the drawings. For example, two consecutive blocks may actually be executed substantially in parallel, or sometimes be executed in a reverse order, depending on functions involved. It should also be noted that each block in a block diagram and/or a flowchart, and combinations of blocks in the block diagrams and/or flowcharts, may be implemented in a dedicated hardware-based system that performs specified functions or actions, or may be implemented by a combination of dedicated hardware and computer instructions.

In addition, the functional modules in the various embodiments according to the present application may be integrated to form an independent part, or each module may exist separately, or two or more modules may be integrated to form an independent part.

If the functions are implemented in the form of software functional modules and sold or used as independent products, the functions may be stored in a computer-readable storage medium. Based on such an understanding, the essence of the technical solutions of the present application, or the part contributing to the conventional technology, or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of the present application. The foregoing storage medium includes media that may store a program code, such as a USB flash disk, a mobile hard disk, a read-only memory (Read-Only Memory, ROM), a random access memory (Random Access Memory, RAM), a magnetic disk, or an optical disk.

The foregoing descriptions are merely the embodiments of the present application, but are not intended to limit the protection scope of the present application. For a person skilled in the art, various changes and variations may be made in the present application. Any modification, equivalent replacement, or improvement made within the spirit and principle of the present application shall be included in the protection scope of the present application. It should be noted that similar reference signs and letters indicate similar items in the following drawings. Therefore, once a specific item is defined in one drawing, it does not need to be further defined and explained in the subsequent drawings.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application should be subject to the protection scope of the claims.

It should be noted that in this specification, relational terms such as “first” and “second” are only used to distinguish one entity or operation from another, and do not necessarily require or imply that any actual relationship or sequence exists between these entities or operations. In addition, the terms “comprise”, “include” and any other variants thereof are intended to cover non-exclusive inclusion, so that a process, a method, an article, or a device that includes a series of elements not only includes these elements, but may also include other elements not expressly listed, or also include elements inherent to this process, method, article, or device. Without being subject to further limitations, an element defined by a phrase “including one . . . ” does not exclude presence of other identical elements in the process, method, article, or device that includes the element.

What is claimed is:

1. A navigation information processing method, comprising:
acquiring motion state information of a vehicle based on an inertial device, and acquiring vehicle information of the vehicle based on a controller area network;
performing a strapdown solution on the motion state information to obtain navigation information;
fusing the navigation information and the vehicle information by using a preset Kalman filter to obtain target navigation information, wherein an input vector of the Kalman filter is a two-dimensional vector; and
navigating the vehicle based on the target navigation information.

2. The navigation information processing method according to claim 1, wherein the acquiring motion state information of a vehicle based on an inertial device comprises:
acquiring a three-axis acceleration and a three-axis angular velocity of the vehicle based on the inertial device;
calculating position coordinates, a three-dimensional motion velocity, and an attitude quaternion of the vehicle based on the three-axis acceleration and the three-axis angular velocity; and
constructing a state vector of the vehicle based on the position coordinates, the three-dimensional motion velocity, and the attitude quaternion, and using the state vector as the motion state information.

3. The navigation information processing method according to claim 1, wherein the acquiring vehicle information of the vehicle based on a controller area network comprises:
acquiring, based on the controller area network, a target steering angle and a target movement velocity of the vehicle in a target time period;
calculating an angle residual value of the target steering angle and a velocity residual value of the target movement velocity; and
using the target steering angle and the target movement velocity as the vehicle information when the angle residual value is less than a first preset threshold and the velocity residual value is less than a second preset threshold.

4. The navigation information processing method according to claim 3, further comprising:
calculating a difference between adjacent target movement velocities in the target time period to obtain a plurality of velocity difference values;
determining a first quantity of velocity difference values greater than a preset velocity value in the plurality of velocity difference values; and
summing the first quantity of velocity difference values greater than the preset velocity value to obtain a velocity difference value sum,
wherein the calculating a velocity residual value of the target movement velocity comprises:
calculating the velocity residual value of the target movement velocity by using a velocity residual value calculation formula, wherein the velocity residual value calculation formula is as follow:
$${E}_{v} = \frac{abs ( {V}_{sum} )}{{m}^{2}} ,$$
wherein Eᵥ is the velocity residual value, Vₛᵤₘ is the velocity difference value sum, and m is the first quantity.

5. The navigation information processing method according to claim 3, further comprising:
calculating a difference between adjacent target steering angles in the target time period to obtain a plurality of angle difference values;
determining a second quantity of angle difference values greater than a preset angle value in the plurality of angle difference values; and
summing the second quantity of angle difference values greater than the preset angle value to obtain an angle difference value sum,
wherein the calculating an angle residual value of the target steering angle comprises:
calculating the angle residual value of the target steering angle by using an angle residual value calculation formula, wherein the angle residual value calculation formula is as follow:
$${E}_{θ} = \frac{abs ( {θ}_{sum} )}{{n}^{2}} ,$$
wherein E_{θ} is the angle residual value, θₛᵤₘ is the angle difference value sum, and n is the second quantity.

6. The navigation information processing method according to claim 3, wherein the acquiring, based on the controller area network, a target steering angle and a target movement velocity of the vehicle in a target time period comprises:
acquiring, based on the controller area network, a steering angle and a movement velocity of the vehicle in the target time period;
determining a first difference value between a time for acquiring the steering angle and a time for acquiring the motion state information, and a second difference value between a time for acquiring the movement velocity and a time for acquiring the motion state information; and
using the steering angle as the target steering angle and using the movement velocity as the target movement velocity when both the first difference value and the second difference value are less than a preset difference value.

7. The navigation information processing method according to claim 1, wherein the motion state information comprises position coordinates, a three-dimensional motion velocity, and an attitude quaternion, and the performing a strapdown solution on the motion state information to obtain navigation information comprises:
separately performing differentiation on the position coordinates, the three-dimensional motion velocity, and the attitude quaternion to obtain a first derivative result, wherein a derivative result of the three-dimensional motion velocity is a three-dimensional motion acceleration;
performing bias correction on the three-dimensional motion acceleration in the first derivative result to obtain a second derivative result; and
performing fourth-order approximation operation on the second derivative result to obtain the navigation information.

8. The navigation information processing method according to claim 7, wherein the performing bias correction on the three-dimensional motion acceleration in the first derivative result to obtain a second derivative result comprises:
performing the bias correction on the three-dimensional motion acceleration by using a preset calculation formula to obtain an acceleration correction result, and forming the second derivative result by using a derivative result of the position coordinates, a derivative result of the attitude quaternion, and the acceleration correction result, wherein the preset calculation formula is as follow:
f_{xyz}=C_{b}ⁿf_{sf}^{b}−(2wᵢₑ+wₑₙ)×vₑₙ+g,
wherein f_{xyz} is an acceleration correction result, C_{b}ⁿ is a navigation coordinate system, f_{sf}^{b} is a three-dimensional motion acceleration, 2wᵢₑ×vₑₙ is a Coriolis acceleration caused by vehicle motion and rotation of the earth, wₑₙ×vₑₙ is a centripetal acceleration to the ground caused by the vehicle motion, and g is a gravitational acceleration.

9. The navigation information processing method according to claim 7, wherein the performing fourth-order approximation operation on the second derivative result to obtain the navigation information comprises:
performing the fourth-order approximation operation on the second derivative result by calculating a slope to obtain the navigation information, wherein a process of calculating the slope is as follow:
$${K}_{1} = {X}_{ndot} ;$$
$${X}_{n + 1} = {X}_{n} + \frac{dt}{2} \times {K}_{1} ;$$
$${K}_{2} = {X}_{n + 1 dot} ;$$
$${X}_{n + 2} = {X}_{n + 1} + \frac{dt}{2} \times {K}_{2} ;$$
$${K}_{3} = {X}_{n + 2 dot} ;$$
$${X}_{n + 3} = {X}_{n + 2} + dt \times {K}_{3} ;$$
$${K}_{4} = {X}_{n + 3 dot} ;$$
$${X}_{n + 4} = {X}_{n} + \frac{dt}{6} ( {K}_{1} + 2 \times {K}_{2} + 2 \times {K}_{3} + {K}_{4} ) ,$$
wherein Xₙ₊₄ is the navigation information, X_{ndot} is the second derivative result, K₁ to K₄ are the slopes at different times in the target time period from a beginning to an end, Xₙ to Xₙ₊₃ are the motion state information at different times in the target time period from the beginning to the end, X_{n+1dot} to X_{n+3dot} are derivative results at different times in the target time period from the beginning to the end, and dt is a time interval between two times.

10. The navigation information processing method according to claim 1, wherein the vehicle information comprises a steering angle and a movement velocity, and the fusing the navigation information and the vehicle information by using a preset Kalman filter to obtain target navigation information comprises:
obtaining an angle residual value of the steering angle and a velocity residual value of the movement velocity;
forming a two-dimensional observation vector by using the steering angle and the movement velocity, and forming an observation noise by using the angle residual value and the velocity residual value;
calculating a Kalman gain value of the Kalman filter based on the observation noise; and
performing data correction on the navigation information based on the two-dimensional observation vector and the Kalman gain value to obtain the target navigation information.

11. The navigation information processing method according to claim 10, wherein the performing data correction on the navigation information based on the two-dimensional observation vector and the Kalman gain value to obtain the target navigation information comprises:
performing, by using a data correction formula, the data correction on the navigation information based on the two-dimensional observation vector and the Kalman gain value to obtain the target navigation information, wherein the data correction formula is as follow:
\hat{X}ₖ⁺=\hat{X}ₖ⁻+Kₖ(zₖ−Hₖ\hat{X}ₖ⁻),
wherein \hat{X}ₖ⁺ is the target navigation information at a current time; \hat{X}ₖ⁻ is a target navigation information at a previous time of the current time; Zₖ is the two-dimensional observation vector; and Kₖ is the Kalman gain value that is equal to Pₖ⁻H_{K}^{T}(HₖPₖ⁻Hₖ^{T}+Rₖ)⁻¹, wherein H is a transition matrix, P is a covariance, and Rₖ is the observation noise.

12. An electronic device comprising a memory and a processor, wherein the memory is configured to store a computer program, and the processor runs the computer program to cause the electronic device to perform a navigation information processing method, comprising:
acquiring motion state information of a vehicle based on an inertial device, and acquiring vehicle information of the vehicle based on a controller area network;
performing a strapdown solution on the motion state information to obtain navigation information;
fusing the navigation information and the vehicle information by using a preset Kalman filter to obtain target navigation information, wherein an input vector of the Kalman filter is a two-dimensional vector; and
navigating the vehicle based on the target navigation information.

13. The electronic device according to claim 12, wherein the acquiring motion state information of a vehicle based on an inertial device comprises:
acquiring a three-axis acceleration and a three-axis angular velocity of the vehicle based on the inertial device;
calculating position coordinates, a three-dimensional motion velocity, and an attitude quaternion of the vehicle based on the three-axis acceleration and the three-axis angular velocity; and
constructing a state vector of the vehicle based on the position coordinates, the three-dimensional motion velocity, and the attitude quaternion, and using the state vector as the motion state information.

14. The electronic device according to claim 12, wherein the acquiring vehicle information of the vehicle based on a controller area network comprises:
acquiring, based on the controller area network, a target steering angle and a target movement velocity of the vehicle in a target time period;
calculating an angle residual value of the target steering angle and a velocity residual value of the target movement velocity; and
using the target steering angle and the target movement velocity as the vehicle information when the angle residual value is less than a first preset threshold and the velocity residual value is less than a second preset threshold.

15. The electronic device according to claim 14, wherein the acquiring, based on the controller area network, a target steering angle and a target movement velocity of the vehicle in a target time period comprises:
acquiring, based on the controller area network, a steering angle and a movement velocity of the vehicle in the target time period;
determining a first difference value between a time for acquiring the steering angle and a time for acquiring the motion state information, and a second difference value between a time for acquiring the movement velocity and a time for acquiring the motion state information; and
using the steering angle as the target steering angle and using the movement velocity as the target movement velocity when both the first difference value and the second difference value are less than a preset difference value.

16. The electronic device according to claim 12, wherein the motion state information comprises position coordinates, a three-dimensional motion velocity, and an attitude quaternion, and the performing a strapdown solution on the motion state information to obtain navigation information comprises:
separately performing differentiation on the position coordinates, the three-dimensional motion velocity, and the attitude quaternion to obtain a first derivative result, wherein a derivative result of the three-dimensional motion velocity is a three-dimensional motion acceleration;
performing bias correction on the three-dimensional motion acceleration in the first derivative result to obtain a second derivative result; and
performing fourth-order approximation operation on the second derivative result to obtain the navigation information.

17. The electronic device according to claim 16, wherein the performing bias correction on the three-dimensional motion acceleration in the first derivative result to obtain a second derivative result comprises:
performing the bias correction on the three-dimensional motion acceleration by using a preset calculation formula to obtain an acceleration correction result, and forming the second derivative result by using a derivative result of the position coordinates, a derivative result of the attitude quaternion, and the acceleration correction result, wherein the preset calculation formula is as follow:
f_{xyz}=C_{b}ⁿf_{sf}^{b}−(2wᵢₑ+wₑₙ)×vₑₙ+g,
wherein f_{xyz} is an acceleration correction result, C_{b}ⁿ is a navigation coordinate system, f_{sf}^{b} is a three-dimensional motion acceleration, 2wᵢₑ×vₑₙ is a Coriolis acceleration caused by vehicle motion and rotation of the earth, wₑₙ×vₑₙ is a centripetal acceleration to the ground caused by the vehicle motion, and g is a gravitational acceleration.

18. The electronic device according to claim 12, wherein the vehicle information comprises a steering angle and a movement velocity, and the fusing the navigation information and the vehicle information by using a preset Kalman filter to obtain target navigation information comprises:
obtaining an angle residual value of the steering angle and a velocity residual value of the movement velocity;
forming a two-dimensional observation vector by using the steering angle and the movement velocity, and forming an observation noise by using the angle residual value and the velocity residual value;
calculating a Kalman gain value of the Kalman filter based on the observation noise; and
performing data correction on the navigation information based on the two-dimensional observation vector and the Kalman gain value to obtain the target navigation information.

19. A non-transitory computer-readable storage medium on which a computer program is stored, wherein when the computer program is executed by a processor, a navigation information processing method is implemented, comprising:
acquiring motion state information of a vehicle based on an inertial device, and acquiring vehicle information of the vehicle based on a controller area network;
performing a strapdown solution on the motion state information to obtain navigation information;
fusing the navigation information and the vehicle information by using a preset Kalman filter to obtain target navigation information, wherein an input vector of the Kalman filter is a two-dimensional vector; and
navigating the vehicle based on the target navigation information.

20. The non-transitory computer-readable storage medium according to claim 19, wherein the vehicle information comprises a steering angle and a movement velocity, and the fusing the navigation information and the vehicle information by using a preset Kalman filter to obtain target navigation information comprises:
obtaining an angle residual value of the steering angle and a velocity residual value of the movement velocity;
forming a two-dimensional observation vector by using the steering angle and the movement velocity, and forming an observation noise by using the angle residual value and the velocity residual value;
calculating a Kalman gain value of the Kalman filter based on the observation noise; and
performing data correction on the navigation information based on the two-dimensional observation vector and the Kalman gain value to obtain the target navigation information.
